(19) United States
(12) Patent Application Publication
(10) Pub. No.: US 2026/0013974 A1
(43) Pub. Date: Jan. 15, 2026

(54) Interdental brush system

(71) Applicant: Parallel Capture Brands, Inc., Wilton, CT (US)

(72) Inventor: Brett W. Thornton, Wilton, CT (US)

(21) Appl. No.: 18/992,971

(22) PCT Filed: Jul. 10, 2023
(86) PCT No.: PCT/US2023/027300

§ 371 Date: Jan. 9, 2025

Related U.S. Application Data
(60) Provisional application No. 63/368,048, filed on Jul. 9, 2022.

(51) Int. Cl. A61C 15/00; A46B 3/18; A46B 5/00; A46B 5/02; A46B 9/06

(52) U.S. Cl. CPC A61C 15/00; A46B 3/18; A46B 5/0041; A46B 5/0095; A46B 5/021; A46B 9/06; A46B 2200/108

(57) ABSTRACT

A brush receiver handle and brush for cleaning interproximal spaces, for example, between teeth. In one embodiment, a removable interdental brush comprises at least one bend for helping to secure the interdental brush in an interdental brush receiver handle.

### FIELD OF THE INVENTION

The invention relates to interdental brush devices and in particular to a handle and to an interdental brush, respectively, for an interdental brush device.

### BACKGROUND

Various types of twisted wire brushes can be used to reach between teeth to clean the interdental spaces. The shape and the size of the teeth and the spacing between them may vary from user to user, and twisted wire brushes are available in various shapes and sizes to accommodate this variety of situations.

Further, some types of interdental brush receiver handles are known for retaining a replaceable interdental brush for use. Some types of users (e.g., the elderly) may have issues, such as impaired vision and hand-eye coordination, or stiffness or pain in their hands, that limit their ability to manipulate a brush and handle to remove and/or install a replaceable brush into a handle. Despite the importance of the ease of brush installation and replacement in a handle, current interdental brush devices fail to provide an interdental brush receiver handle wherein the user can easily insert or remove a twisted wire brush.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a perspective view of an interdental brush receiver handle according to an embodiment of the present invention;

FIG. 2 is another perspective view of the interdental brush receiver handle of FIG. 1 according to an embodiment of the present invention;

FIG. 3 is a top elevation view of the interdental brush receiver handle of FIG. 1;

FIG. 4 is a bottom elevation view of the interdental brush receiver handle of FIG. 1;

FIG. 5 is a side plan view of the interdental brush receiver handle of FIG. 1;

FIG. 6 is a side plan view of the interdental brush receiver handle of FIG. 1;

FIG. 7 is a rear plan view of the interdental brush receiver handle of FIG. 1;

FIG. 8 is a front plan view of the interdental brush receiver handle of FIG. 1;

FIGS. 9A and 9B are perspective views of an interdental brush system according to an embodiment of the present invention; and

FIG. 10 is a perspective view of an interdental brush.

### DETAILED DESCRIPTION

According to some embodiments, an interdental brush receiver handle of the present invention offers improvements to retaining structures for twisted wire brushes and other types of interdental brushes and cleaners.

In one embodiment, an interdental brush receiver handle for holding a twisted wire brush comprises a handle with a locking receiver head section.

In accordance with one embodiment, the interdental brush receiver handle comprises a receiver head having two opposing sides, each side being adjacent to a living hinge or other connecting means to connect the two sides. In accordance with an alternative embodiment, the two opposing sides can be separated from one another (e.g., they are not connected by a living hinge or any other type of permanent connection).

In one embodiment, at least one of the opposing sides of the receiver head comprises a channel for receiving a brush (e.g., a twisted wire brush for cleaning between teeth). In one embodiment, the channel comprises at least one bend or angle for receiving a brush configured with a corresponding bend or angle. In one or more embodiments, each opposing side comprises a corresponding opposite channel portion for retaining a brush when the opposing sides are closed together.

In one alternative embodiment, the channel is straight and does not comprise a bend or angle.

According to some embodiments, the opposing sides of the receiver head comprise corresponding locking portions. In one embodiment, a first opposing side comprises a clip and the second opposing side comprises a gap for receiving the clip for locking the opposing sides together.

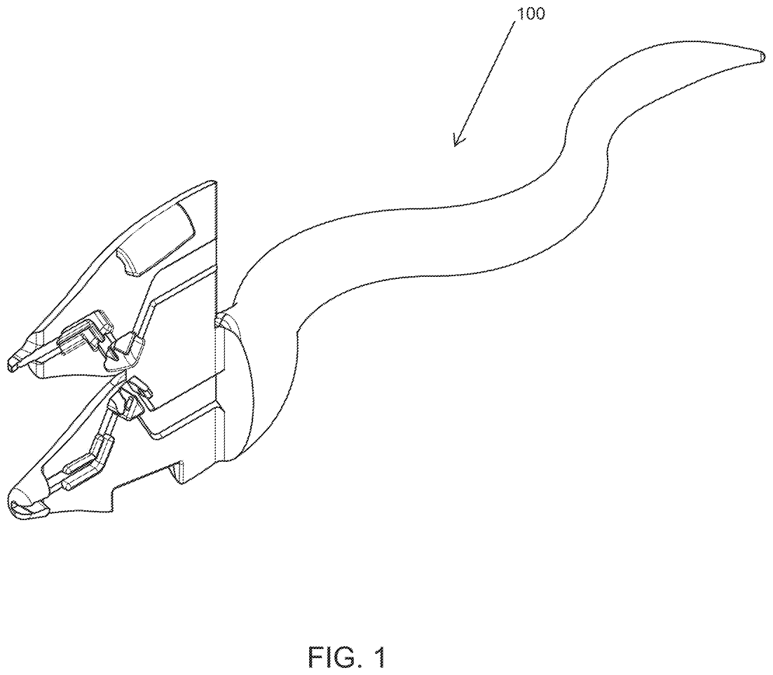

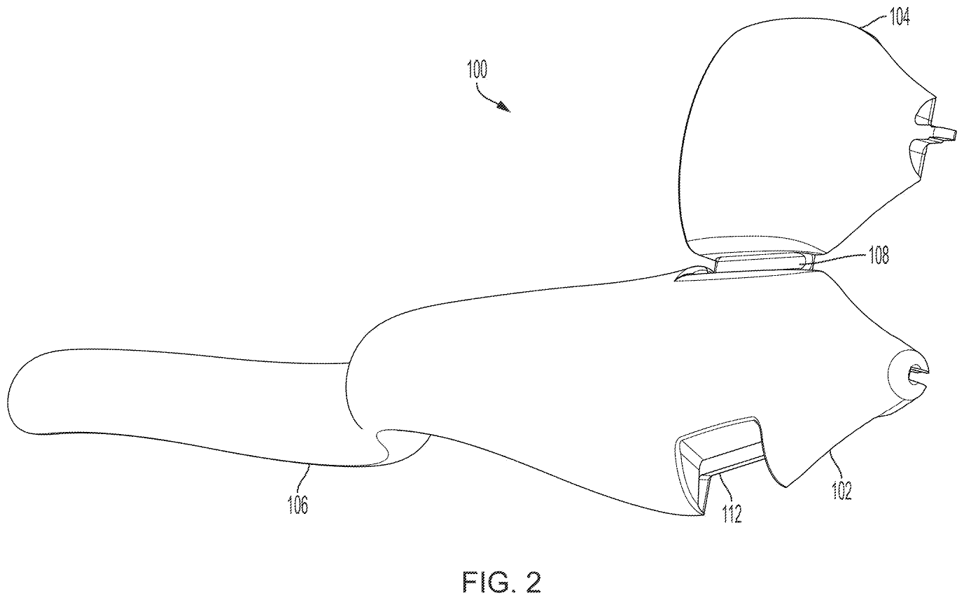

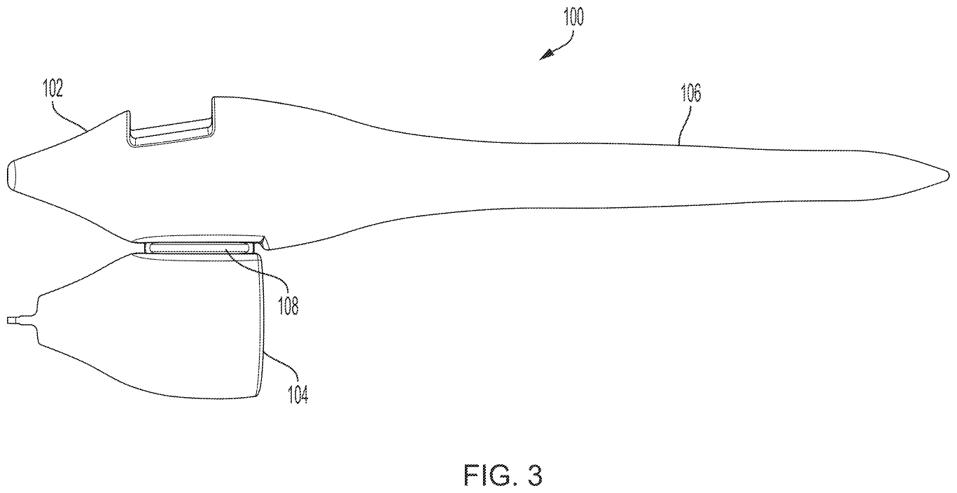

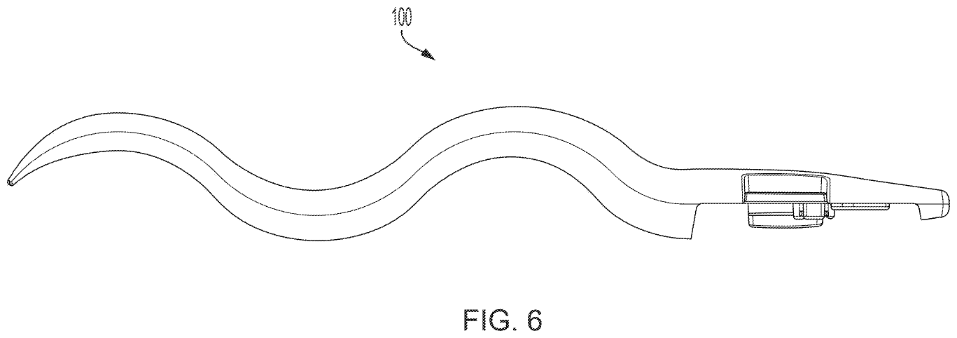

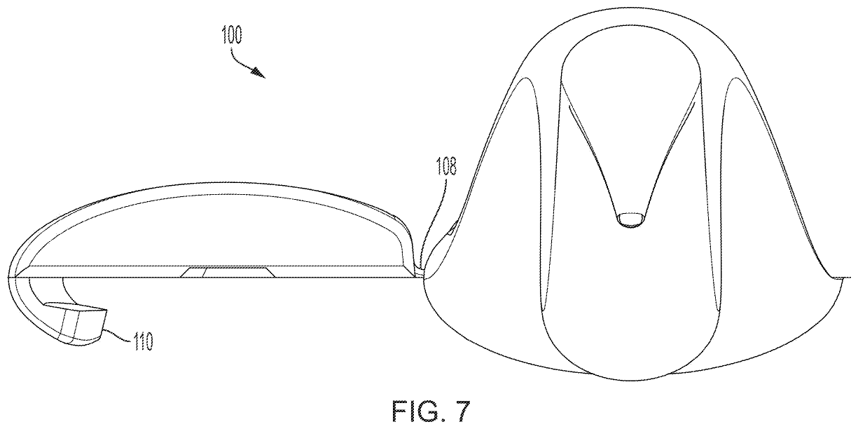

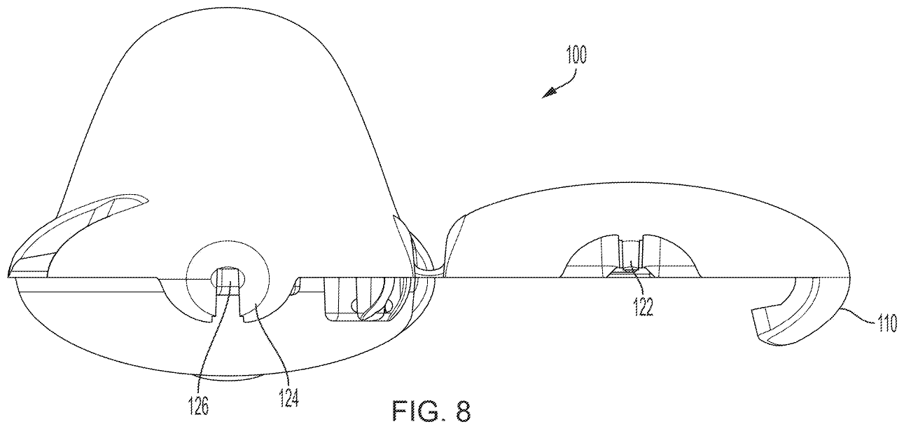

Some features in accordance with some embodiments of the present invention are described below with respect to the figures. Referring to FIGS. 1-8, an interdental brush receiver handle 100 comprises a first side 102 of a receiver head and a second side 104 of the receiver head connected to the first side 102 by hinge 108 (e.g., a living hinge). In accordance with some embodiments, the interdental brush receiver handle 100 further comprises a handle section 106 by which a user would preferably hold the interdental brush receiver handle when using it to clean their teeth. According to some embodiments, the interdental brush receiver handle 100 may be made of polypropylene, molten polymer, and/or other material suitable for molding or otherwise forming in desired configurations, such as wood, plastic, and rubberized plastic).

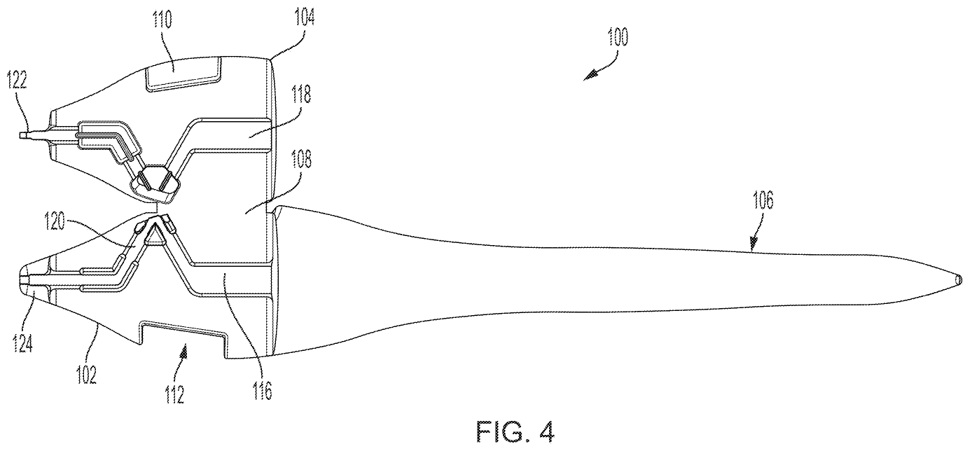

Referring to FIG. 4, the receiver head of the interdental brush receiver handle 100 comprises a receiver head locking latch 110 for latching through corresponding receiver head locking latch receiver 112 when the opposing sides of the receiver head are closed together (e.g., are rotated to meet using hinge 108).

As depicted in FIG. 4, according to some embodiments each opposing side of the receiver head of the interdental brush receiver handle 100 comprises a channel 116 or 118, respectively, for receiving an interdental brush (not shown). In accordance with some embodiments, the channel portions 116 and 118 have at least one bend or angle 120 configured to fit an interdental brush having a corresponding bend or angle (e.g., in a twisted wire core that is installed in the receiver head for use).

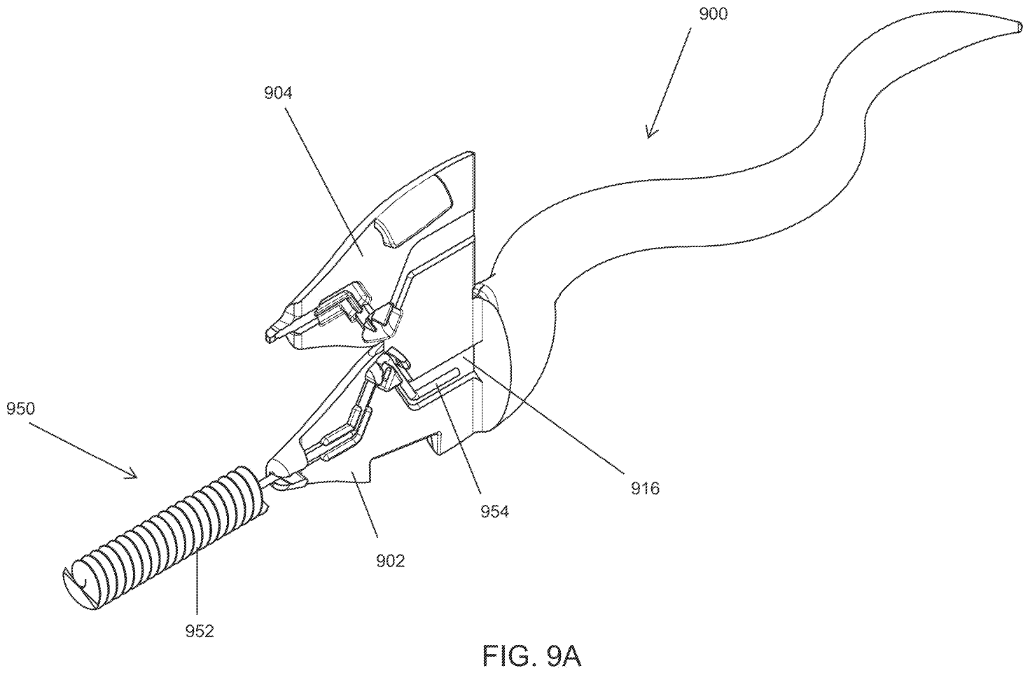

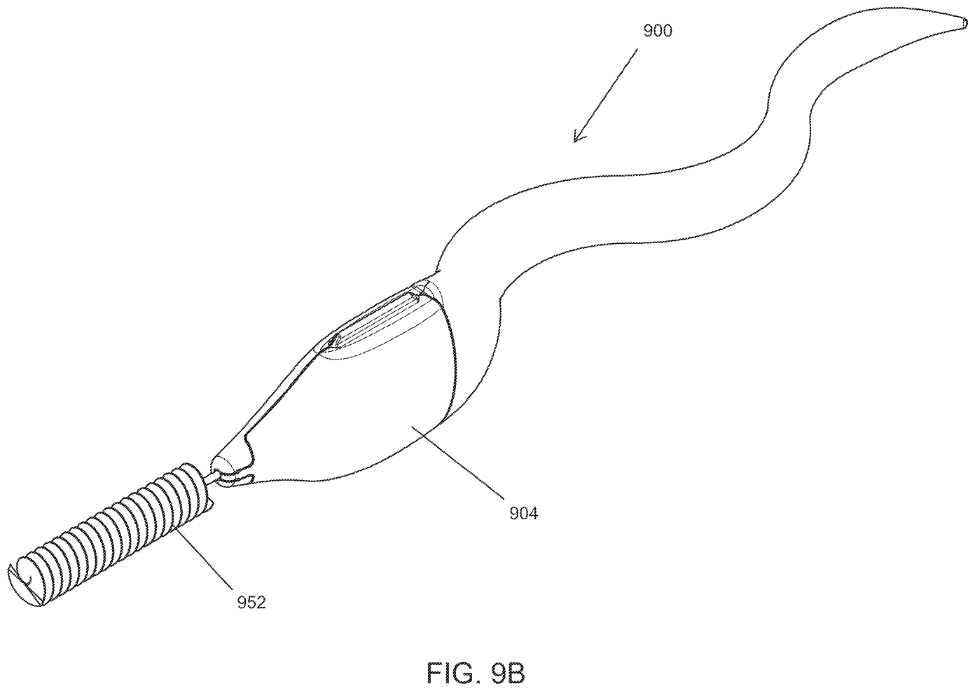

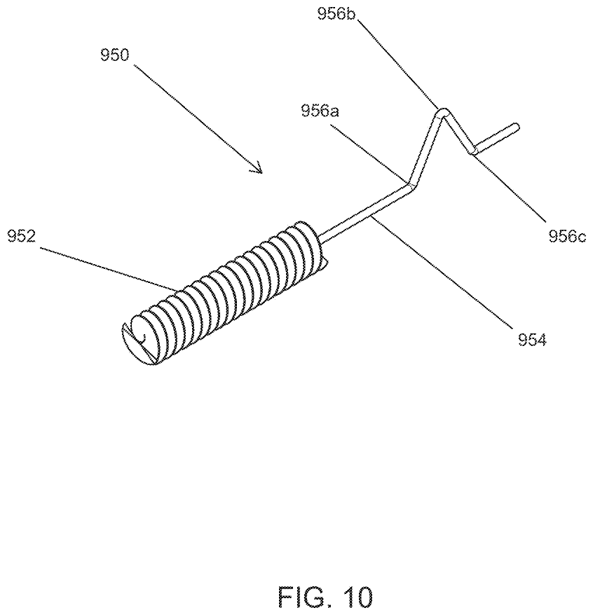

In accordance with some embodiments, the interdental brush receiver handle 100 further comprises at the proximal end an egress groove, formed by end portions 122 and 124 when the opposing sides 102 and 104 of the receiver head are closed together, for a stem portion of an interdental brush to exit the receiver head. When installed, the stem portion of an interdental brush extends through the formed opening. Additional details of an example interdental brush and interdental brush system are described with respect to FIGS. 9A, 9B, and 10.

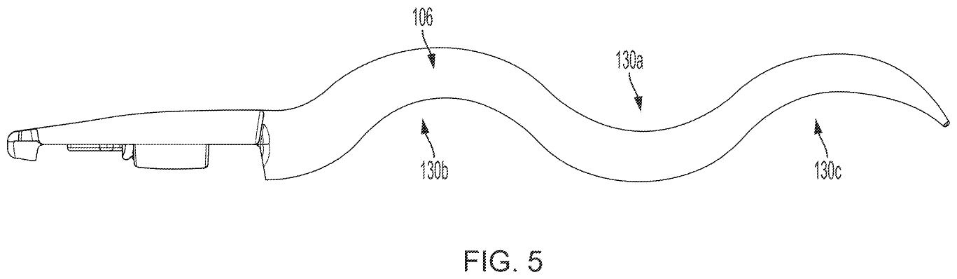

Referring now to FIG. 5, in accordance with some embodiments, the handle section 106 comprises at least one bend 130a-c. According to some embodiments, at least one bend in the handle section 106 provides an improved ergonomic design, making it easier for a user to hold and manipulate the interdental brush receiver handle 100 to clean interdental spaces.

In one example, the handle section 106 has an ergolinear configuration (e.g., an S-shape) that fits between the thumb on one side and the fore finger and middle finger on the opposite side. Example bends 130a, 130b, and 130c all for placement of the thumb, forefinger, and middle finger, respectively, when a user holds the handle section 106.

The increased fine motor control that is afforded to a user through utilizing an ergolinear handle section reduces the chance of slippage and injury as the user manually guides the brush end into small and hard-to-reach spaces between teeth and around and below the gum line.

Referring now to FIGS. 9A, 9B, and 10, components of an example interdental brush system 900 are described, in accordance with some embodiments. As depicted in FIGS. 9A and 9B, an interdental brush 950 is installed in first side 902 of a receiver head of the interdental brush system 900. Specifically, a dimpled brush stem 958 of the interdental brush 950 is recessed in channel 916 of first side 902. FIG. 9B shows an example wherein second side 904 of the receiver is closed (e.g., using a latch or other type of securing means), securing the dimpled brush stem 958 (FIG. 9A) inside the receiver head.

FIG. 10 shows an example interdental brush 950 comprising interdental brush head 952 and dimpled brush stem 954. As shown in FIG. 10, example dimpled brush stem 954 has three bends 956a-c, forming a “dimple” in the dimpled brush stem 954. The resulting shape of dimpled brush stem 954 corresponds to the shape of channel 916, for example, in first side 902 of the example interdental brush system 900. The angled shape of the stem and channel advantageously prevent the stem from simply sliding out of the receiver head, as would be possible with a straight stem and channel, resulting in a more secure way to connect the interdental brush 950 to the receiver handle.

In accordance with some embodiments, the interdental brush head 952 may comprise yarn (e.g., a texturized nylon yarn), monofilament bristles (e.g., bristles with a diameter between 0.05 mm and 0.01 mm), and/or any combination of the foregoing (e.g., a hybrid yarn and bristle brush head). Other types of materials suitable for interdental cleaning and cleaning other types of objects may be substituted as deemed desirable for a particular implementation and cleaning purpose.

According to some embodiments, the interdental brush 950 may be produced by folding a single wire in half, inserting bundles of cleaning materials (e.g., filaments such as nylon yarn and/or monofilament bristles) between the folded wire and twisting the wire to form a twisted wire core having the interdental brush head 952 at one end. In one embodiment, a stem portion of the interdental brush 950 opposite the interdental brush head 952 and for inserting in a handle of an interdental brush system, may be bent or otherwise manipulated to form one or more bends of the dimpled brush stem 958.

In one embodiment, the interdental brush head 952 may comprise a plurality of texturized nylon filament yarn strands (e.g., clamped in twisted wire). According to some embodiments, a “tuft zone” located at a first region nearest the twisted wire core after the yarn is free from the twisted wire core, is denser than the rest of the yarn strand and has less propensity to move back-and-forth laterally when deployed by the user for the purposes of oral care. The extra energy required to move this yarn strand section back-and-forth, creates a gentle increase in resistance and, therefore, greater cleaning and massaging capabilities on the teeth and gums. According to some embodiments, one novel characteristic of the “tuft zone” region of the yarn strand is the angle that is created by the sides of the “tuft,” relative to the uncompressed width of the upper part of the yarn strand. Accordingly, for embodiments using nylon yarn strands that have compression memory properties (e.g., texturized yarn), an obtuse angle may be formed by the yarn strand on each side of the tuft zone nearest the twisted wire. This angle creates a scoring effect, increasing cleaning efficacy in the removal of plaque debris around dental appliances, such as bridges, implants and orthodontic braces, as well as below the gum line.

According to some embodiments, an implementation of the interdental brush head 952 may be formed by alternating types of cleaning material in a twisted wire, such as by inserting a set of nylon yarn filaments (e.g., a 1/16 inch bundle), then an adjacent set of monofilament bristles (e.g., a 1/16 inch bundle), then another set of nylon yarn, and so on, to form the interdental brush head 952 of interdental brush 950. As discussed with respect to some embodiments, nylon yarn filaments (e.g., texturized yarn) have hydrophilic properties and absorb liquids. Accordingly, using texturized yarn as an alternating band in the brush head allows for the delivery of any sort of liquid to the interproximal area, be it chlorhexidine, fluoride, or any other oral drug to be delivered topically.

In one or more embodiments of the disclosure, as noted above, the interdental brush 950 may be produced in the twisted-in-wire brush construction fashion. In one example manufacturing process, between 6 and 20, reel-fed, continuous elements of nylon yarn and/or monofilament bristles are fed between a pre-cut, u-shaped section of wire. These elements preferably are fed in an orientation that is perpendicular to the wire, or, across the wire rather than parallel to it. In one example, the material is fed between the closed end only, leaving a length on the open end that will serve as the dimpled brush stem 958. The inserted elements may then be cut into strands of desired length (e.g., 1 inch). The closed end of the wire section is held in a rotating, vise-like apparatus and the opposite, open end of the wire section is held in a similar vise-like apparatus. The two vises are rotated in opposite directions until the wire twists together and clamps the materials in place, firmly between the wires.

In one or more embodiments, wire used for producing an interdental brush head 950 may be a steel wire having a diameter of 0.25 to 0.35 mm (e.g., SUS304 stainless steel wire).

An interdental brush head 952, in accordance with various embodiments, may be any shape, and comprise strands of any thickness and/or any diameter. For example, the shape of the interdental brush head 950 may be curved, straight, conical, bent into a u-shape or circular shape.

According to some embodiments of the present invention, the materials of the interdental brush head 952 (e.g., nylon filament yarn strands) may have hydrophilic characteristics. A substrate of nylon yarn, for example, is easily wetted by all manner of liquids. In this way, the yarn strands are able to deliver meaningful amounts of liquid. Drugs, hydrogen peroxide, chlorhexidine, fluoride and the like, can be applied to the yarn strands of the brush and directly targeted to an area of the dentition where these types of materials will be of optimal benefit. According to some embodiments, a liquid coating may be applied at the point of manufacture in the factory and be allowed to dry. The user can then “rehydrate” the coating at the point of use, thus reconstituting the benefits of the coating medium. This may be done with a tooth whitening agent, any powdered drug, and/or other type of powdered material.

Any combination, denier, diameter or texture of bristles and/or yarn strands is possible in the manufacture of the present invention, as deemed appropriate for a desired implementation.

According to one embodiment, the type of wire used in the interdental brush is a plastic-coated, stainless steel alloy. The typical range of wire thickness used for interdental applications is: 0.2 mm to 1.5 mm.

According to some embodiments, in addition to compression memory characteristics, nylon filament yarn strands in a brush head (e.g., interdental brush head 952) may “tuft up” and offer gentle resistance, instead of merely bending or lying flat (like monofilament bristles do) when inserted into an interproximal space.

### Interpretation

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (as may be set forth at the beginning of the first page of this disclosure) nor the Abstract (as may be set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. An interdental brush system comprising:
an interdental brush receiver handle comprising:
a handle section; and
a receiver head attached to the handle section for retaining an interdental brush,
wherein the receiver head comprises a channel for receiving the interdental brush, and
wherein the channel comprises at least one bend; and
an interdental brush comprising:
an interdental brush head, and
a dimpled brush stem comprising at least one bend in accordance with the channel of the interdental brush receiver handle.

2. An interdental brush comprising:
an interdental brush head, and
a dimpled brush stem comprising at least one bend configured in accordance with a channel of an interdental brush receiver handle to secure the interdental brush head in the interdental brush receiver handle.

3. The interdental brush of claim 2, wherein the interdental brush head comprises at least one nylon yarn strand, each strand comprising a plurality of filaments.

4. The interdental brush of claim 2, wherein the interdental brush head comprises sets of nylon yarn strands alternating with sets of monofilament bristles.

5. The interdental brush of claim 2, wherein the interdental brush head and the dimpled brush stem are formed using a twisted wire core.

6. The interdental brush of claim 2, wherein the interdental brush head comprises filaments having hydrophilic characteristics.

7. The interdental brush of claim 2, wherein a shape of the dimpled brush stem comprises three bends.

8. A device comprising:
a handle section; and
a receiver head attached to the handle section for retaining an interdental brush,
wherein the receiver head comprises a channel for receiving the interdental brush, and
wherein the channel comprises at least one bend.

9. The device of claim 8, wherein the handle section comprises an ergolinear handle.

10. The device of claim 9, the ergolinear handle comprising at least two curved portions configured for respective placement of a user's fingers.

11. The device of claim 8, wherein the receiver head comprises a first opposing side and wherein the first opposing side comprises the channel for receiving the interdental brush.

12. The device of claim 11, wherein the receiver head further comprises a second opposing side configured to be detachably secured to the first opposing side.

13. The device of claim 12, wherein the first opposing side and the second opposing side further are connected with a living hinge.
